(19) United States
(12) Patent Application Publication
(10) Pub. No.: US 2023/0103806 A1
(43) Pub. Date: Apr. 6, 2023

(54) METHOD FOR MANUFACTURING A PART OF NITRIDED STEEL

(71) Applicant: SAFRAN, Paris (FR)

(72) Inventors: Jawad BADREDDINE, MOISSY-CRAMAYEL (FR); Simon THIBAULT, MOISSY-CRAMAYEL (FR)

(73) Assignee: SAFRAN, Paris (FR)

(21) Appl. No.: 17/905,017

(22) PCT Filed: Feb. 26, 2021
(86) PCT No.: PCT/FR2021/050333

§ 371 Date: Aug. 25, 2022

(30) Foreign Application Priority Data
Feb. 28, 2020 (FR) 2002032

(51) Int. Cl. C21D 10/00; C21D 8/00; C21D 1/06; C23C 8/26; C21D 6/00

(52) U.S. Cl. CPC C21D 10/005; C21D 8/005; C21D 1/06; C23C 8/26; C21D 6/00; C21D 2261/00

(57) ABSTRACT

A method for manufacturing a part of nitrided steel includes a step of nitriding the part. After nitriding, laser shocking is carried out on a surface of the nitrided part.

### TECHNICAL FIELD OF THE INVENTION

The present invention relates to the general field of manufacturing a part of nitrided steel.

A favoured application refers to the production of aircraft turbine-engine parts.

The manufacture of various power transmission parts is in particular concerned.

### PRIOR ART

Nitriding weakly alloyed steel is a conventional solution for many parts, including power transmission parts, in particular when the operating temperature does not make it possible to use case-hardened steels. The steel/nitriding solution has already been adopted for manufacturing various parts.

Among power transmission parts, the following can be noted:
gears
fluted shafts
bearing tracks.

Nitriding generates a hardened layer on the surface and typically on the subsurface (over a few hundredths of mm) of the part. This method also generates a layer of iron nitride referred to as “combination layer” or “white layer”, generally subsequently removed, because of its fragile character, this typically being followed by a shot-blasting step for mechanical reinforcement. Grinding generally makes it possible to remove this combination layer and to provide the final dimensioning of the part.

Among the existing technical problems, the difficulty may be noted that the combination layer has to be removed by grinding.

Two causes for this are the great hardness of the combination layer (problems of cracking) and the accessibility or the clearance for manufacturing tools on the scale of a part.

### SUMMARY OF THE INVENTION

To seek a solution to at least some of the aforementioned problems, the present invention proposes a method for manufacturing a steel part, the method comprising nitriding of the part leading to the formation of a combination layer of iron nitrides (surface layer, typically with a thickness of less than 100 μm; the layer is composed of ε and γ′ nitrides), with the important characteristic that, after nitriding, a laser shock is implemented on the nitrided part so as to remove the combination layer.

Thus, instead according to the prior art of removing the combination layer by grinding, the laser shock will be used which, by generating a shockwave, will remove the combination layer, which therefore constitutes a sacrificial layer.

Moreover, the shockwave generates compressive stresses in the part that are beneficial.

To best accomplish the operations, it is advised that:

before nitriding the part:
a blank of the steel part is manufactured,
the blank is heat treated, and
semi-finishing of the blank is implemented, by machining, to obtain a semi-finished part on which said nitriding is implemented,
   then, for the laser shock, that the laser projects pulses with a power (P) of 5 J≤P≤30 J, preferably 10 J≤P≤30 J, and a duration of each pulse lying between 1 and 30 nanoseconds, preferably between 5 and 30 nanoseconds.

In particular, the laser can usefully project pulses at a wavelength (λ) such that 0.5 μm≤λ≤2 μm.

Also usefully, the laser can in particular have surface power densities of between 5 and 30 GW/cm², and preferably between 2 and 10 GW/cm².

If the surface state is sufficiently satisfactory at the end of the laser shock, it is possible not to implement shot blasting, otherwise shot blasting can be implemented.

Tribofinishing can also be carried out.

Laser shock can be used in the same way as in the known art, since it typically makes it possible to remove a sacrificial layer, which is here the combination layer.

To prepare the laser shock step, it is proposed, before nitriding the part,
to first manufacture a blank of the steel part,
to heat treat the blank, and
to implement semi-finishing of the blank, by machining, on which said nitriding will then be implemented.

In particular in this case, a final grinding step will be avoided, which can be replaced by the laser shock step.

According to the known art, shot blasting can be applied, after the nitriding and the grinding, to increase the residual compressive stress levels (the origin of the mechanical surface reinforcement), on the near surface (depth ranging from the surface −0 μm-to approximately 300 μm).

Thus, the solution of the invention, through the use of laser shock, makes it possible to eliminate the grinding step and can make it possible not to implement the shot-blasting step.

Advantageously, laser shock will also make it possible:
to mechanically reinforce the material (nitrided steel) over greater depths than the conventional methods (as aforementioned, such as shot blasting), this without degrading the surface roughness, and
to use the combination layer generated by the nitriding on the surface of the part as a sacrificial layer for the laser shock method. This will make it possible to dispense with the steps of applying sacrificial layers, as known previously.

Thus, provision is made for the aforementioned method with laser shock on a nitrided part to be able to be devoid both of a step of grinding of the part and a step of applying at least one sacrificial layer on the nitrided part.

To favourably achieve at least one target roughness (at least one, since it could vary according to the relevant zone on the part), it is proposed, after the laser shock on the nitrided part, to implement a finishing of the part, to treat its surface state.

Since laser shock on a nitrided part makes it possible to favour accessibility or clearance for manufacturing tools on the scale of a part, it may be wished, to modify the surface state, including the ridges on parts with ridges, for the finishing of the part to comprise tribofinishing.

To further promote efficiency of the solution, it is proposed for the laser shock to use surface power densities of the laser that vary between 5 GW/cm² and 30 GW/cm², with a duration of pulse of between 5 ns and 30 ns.

In terms of application of the aforementioned method, with all or part of its features, it can in particular be sought for the manufactured part to be one from an aeronautical part or an automobile part, of the type with teeth and/or flutes, gearing (gearwheels in particular) or bearing track, among other things, in order to enable it to withstand the mechanical stresses to which it is subjected and which have the particularity of being concentrated mainly on the surface (bending fatigue, contact fatigue, fretting, wear, etc.).

It should also be noted that the aforementioned method, with all or some of its features, will allow a favoured access to confined zones by making it possible for example to remove a combination layer where conventional methods will not so permit. This is due to the low sensitivity of laser shock at the treatment angles (equivalent to 30° and 90°), and hence an ability to treat any surface capable of being aimed at by the laser generating the shock.

This is because, when a laser shock operation is implemented, the laser beam is directed towards the surface to be treated. The beam can be oriented with respect to the surface to be treated. For example, if the beam arrives perpendicular to the surface, the angle between the surface and the beam is 90°. This is what is called the treatment angle, or angle of fire. Therefore, for an angle of 30°, the beam would arrive with an angle of 30° with respect to the surface of the zone to be treated.

### BRIEF DESCRIPTION OF THE FIGURES

FIG. 1 shows a schematic example of a blank of a part to be treated;

FIG. 2 shows a magnification of the zone II of FIG. 1 (the scale of 20 μm is shown thereon);

FIG. 3 shows a schematic example of a semi-finished part resulting from said blank;

FIG. 4 shows in particular a magnification of the zone IV of FIG. 3, during laser pulses;

FIG. 5 shows the same magnification and shows schematically the effect of the laser shock, and

FIG. 6 shows an enlarged portion of the part without combination layer on the surface (the scale of 20 μm is shown).

### DETAILED DESCRIPTION OF THE INVENTION

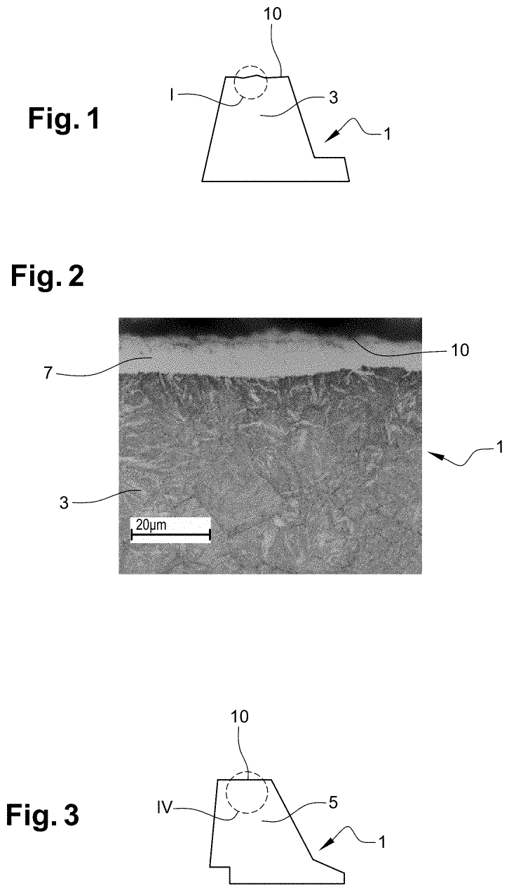

Before, as shown schematically in FIGS. 1 and 2, implementing a laser shock on the surface 10 to be treated of the part 1 concerned, advantageously:
a blank 3 of the steel part 1 will have been manufactured (FIG. 1),
the blank 3 will have been heat treated,
a semi-finishing of the blank will have been implemented, by machining, to obtain a semi-finished part 5 (FIG. 3) on which a nitriding will have been implemented.

In relation to the manufacture of the blank 3 of the steel part 1, it is a case of giving the first form to the part concerned. The blank is obtained by successive “rough” machining steps, which make it possible to obtain the general form of the part. At this stage, surplus material (approximately 0.5 mm of the minimum dimensions) is kept on the surface for the subsequent finishing machining phase, which makes it possible to achieve the required final dimensions of the part.

With regard to the heat treatment of the blank 3, it will often be a case of successive steps, such as for example thermal detensioning, annealing, quenching, cold pass (cryogenic treatment).

Nitriding may, in a traditional manner, consist in immersing the semi-finished part 5 of ferrous alloy (such as an alloyed steel of the chromium-aluminium type) in a medium able to yield up nitrogen (otherwise referred to as nitre) on the surface, at a temperature of between 300° C. and 600° C., where the nitrogen has been able to diffuse from the surface towards the core of the part.

For this nitriding, it is possible in particular to treat the part in a furnace under nitrogenous atmosphere. It is a case of a thermochemical treatment of nitrogen diffusion alone, implemented at between 300 and 900° C. The nitrided zone extends over a depth less than a millimetre.

A weakly alloyed nitriding steel (for example of the 32CrMoV13) type, having typically a carbon content of between 0.20% and 0.45% allowing to give to the base material its core mechanical properties after heat treatment, could be selected.

The surface properties of the steel, such as the hardness, were conferred on it by a nitriding treatment consisting in diffusing nitrogen in ferritic phase, which caused the precipitation of sub-microscopic nitrides from nitride-generating elements such as Cr, V, Mo and Al, present in solid solution in the treated steel.

In concrete terms, in a nitriding treatment, the steel has been able to be treated at a temperature of the order of 500° C. by ammonia, which has decomposed into cracked ammonia and has reacted simultaneously with the iron of the steel. The ammonia has caused the formation of said superficial combination layer consisting therefore of iron nitrides, from which the nitrogen atoms have diffused in the direction of the core of the part to form the diffusion layer.

For a weakly alloyed steel comprising nitride-generating elements, it has been possible to observe two layers after nitriding: the combination layer on the surface consisting of iron nitrides and the diffusion layer in which the precipitates of submicroscopic nitrides are dispersed, giving rise to the increase in hardness found in the nitrided layer. The total depth of the nitriding layer can vary, according to the nitriding conditions and the applications sought, between 0.05 mm and 1 mm.

It is possible in particular to achieve:
a combination layer, on the surface, with a thickness of less than 100 μm, composed of ε and γ′ nitrides, and
under the combination layer, a thicker diffusion layer (from 100 to 1000 μm); the hardness level obtained can be between 400 and 1300 HV (Vickers hardness) and this hardness can be kept up to temperatures of the order of 500° C. The diffusion layer is therefore harder than the combination layer.

The document “Microstructure of a Nitrided Steel Previously Decarburized”, I. Calliari et al., Journal of Materials Engineering and Performance, Vol. 15, No. 6, pages 693-698 (2006, Dec. 1) describes such a method for nitriding a weakly alloyed steel.

In practice, nitriding can however be selected according to the industrial applications and the functional requirement, the fine specificities of the laser shock for removing the combination layer and reinforcing the mechanical material on the subsurface to be determined according to the nitriding layer.

The nitriding of the surface 10 of the semi-finished part 5 will in any event, on the surface (typically over 2 to 40 μm), have generated a combination layer 7 which, in the traditional art, it is then sought to eliminate because in particular of its fragile character. To avoid this and the grinding operation then typically implemented to remove this combination layer 7 and then to allow the final sizing of the semi-finished part 5, the invention therefore makes provision for having recourse to a laser shock.

This technique will in fact make it possible to avoid having to remove the combination layer 7 by grinding, and therefore to avoid the technical difficulties that are related thereto, in particular the problems of:
high hardness of the combination layer (problems of cracking),
accessibility or clearance for grinding tools, which may be insufficient, on the scale of a part.

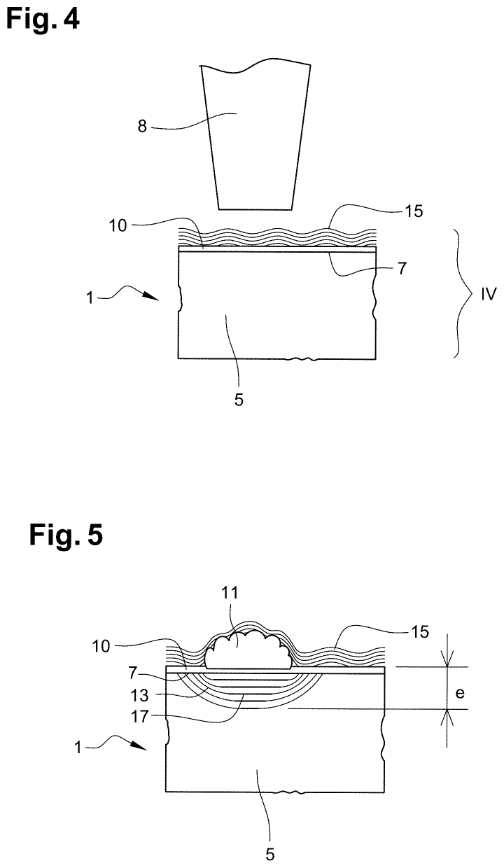

Laser shock is a method for the contactless mechanical reinforcement of a metal surface, here therefore the nitrided steel surface 10. It consists in projecting laser pulses towards the surface to be treated (FIG. 4). The wavelength may be such that 0.5 μm≤λ≤2 μm, with a power 10 J≤P≤30 J and a duration of each pulse of between 1 and 50 ns, preferably between 1 and 30 ns, and preferably again between 5 and 30 nanoseconds. The fluences (surface power density) used can vary typically between 1 and 50 GW/cm² and preferably between 5 and 30 GW/cm², and again preferably between 2 and 10 GW/cm².

In precise terms, it is possible to use a pulsed laser beam 8, with typically an energy of between 3 and 30 J, preferably between 5 and 30 J, and again preferably between 5 and 10 joules, for example 10 J with the Nd:YAG and a duration of 18 nanoseconds, this beam being projected onto the surface 10, in order to create thereon residual compressive stresses.

The firing frequency of the laser can be between 10 Hz and 200 Hz and preferably between 20 Hz and 100 Hz.

Thus, in particular with laser pulses of 1 to 30 ns, a laser energy of 5 to 30 J, and firing frequencies of between 20 Hz and 100 Hz, it will be possible, with power densities ranging from 5 to 30 GW/cm², to have available enough energy to atomise the combination layer 7 in the form of a plasma, which will generate almost no thermal effect in the surrounding material, because of the extremely short durations. Using water as a confinement medium will also assist (see below).

Because of the plasma created, a powerful shockwave will be generated, which will propagate in the material and will mechanically reinforce the material in the same way.

The surface of the part to be treated can:
either directly receive the laser beam, which then requires a subsequent removal of material over a few microns in depth (between 5 and 50 μm typically) in order therefore to remove the layer of sacrificed materials; there are in fact risks of superficial burns of material, if the material is directly exposed to the laser,
or be covered with a material acting as a sacrificial and thermal-protection layer and which may be an adhesive made of aluminium, black vinyl or black polyvinyl chloride (PVC) having a thickness of a few tens of micrometres (30 to 130 μm typically),
and/or be protected by a confinement layer that is a medium transparent to the laser, capable of interacting with the shockwave generated by the plasma caused by the interaction between the laser and the material (sacrificial layer or target material, in the absence of a sacrificial layer).

As is known, such a confinement layer or medium 15 maximises the energy transmitted to the material, by reflecting a part of the shockwave that in propagating moves away from the material (see reference 11 of FIG. 5).

A typical confinement medium 15 is the one defined by a lamellar flow of water, which makes it possible to obtain a continuous flow of constant thickness, on the surface of the part. Such a lamellar film or flow of water could be replaced by another type of fluid having anti-corrosion properties, provided that this fluid is transparent to the wavelength of the laser used.

Whatever the case, there will therefore be an advantage, for the laser shock, in keeping the aforementioned confinement medium 15.

On contact with surface 10, which therefore has the combination layer 7, a plasma 11 is generated, producing an elastic shockwave 13 that passes through the material and causes residual compressive stresses 17 (FIG. 5).

Passing through the transparent confinement layer 15 (if such is provided), the photons of the laser beam 8 are absorbed by the combination layer 7, which therefore acts as a sacrificial layer. This absorption quickly ionises and vaporises the surface material and creates the plasma 11, which absorbs the rest of the laser pulse.

The pressure of the plasma thus formed can reach 100 kBar (1 T/cm²) and is confined by the inertia of the confinement layer 15 flowing over the surface.

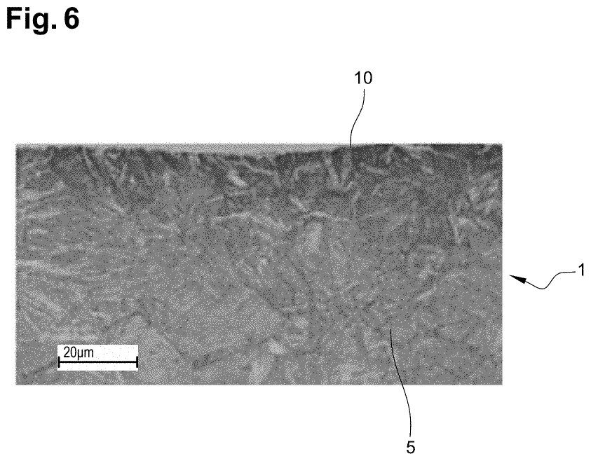

By means of the laser shock generated on the surface 10 of nitrided steel, the combination layer 7 will therefore have been removed without grinding, as can be seen in FIG. 6, and the surface 10 will have been mechanically reinforced.

This technique must make it possible to reinforce the part 1 more deeply than conventional methods: the depth e to which the compression created by the laser shock relates can attain depths of the order of a millimetre, between 1 and 4 mm, for example 3 mm for a stainless steel 304. In comparison, with shot blasting according to the technique previously most often used, the depths are of the order of a few hundreds of micrometres, typically between 100 and 300 μm.

Avoiding having had to seek, and therefore sometimes in fairly inaccessible zones, to remove the combination layer 7 by ad hoc tooling is also an advantage of the invention related to the low sensibility of laser shock to the treatment angles (see above the remarks made on the treatment angles of the laser shock).

Thus, it will in fact be possible to treat any surface 10 capable of being aimed at by the laser beam 8.

At the end of such a treatment by the laser beam 8, it will be possible to implement a finishing of the part, to treat its surface state 10, in order (at least) to achieve (at least) a target roughness, it being stated that there could be different roughnesses at different places on the surface 10.

Achieving this aim will be promoted if tribofinishing is favoured, which will make it possible, via therefore a mechanical or chemical mechanical polishing, to modify the surface state and any ridges (surface 10 and its end ridges, in the example).

Associating the laser shock and the tribofinishing will therefore broaden the scope of this technical solution and the quality of the finished part.

The solution of the invention, with all or some of its features, will have made it possible:
to ensure compatibility of the surface states (their topology) with respect to the functional requirement, in particular for parts that are difficult to treat traditionally by grinding,
to completely eliminate (if possible) the combination layer 7, while controlling the removal thereof (by controlling the laser beam 8),
to eliminate (when applied) the shot-blasting step, while generating residual compressive stresses in a controlled manner,
to implement the laser shock optionally without a confinement medium, or by means of a non-corrosive confinement medium.

1. A method for manufacturing a steel part, the method comprising the steps of:
nitriding the part leading to the formation of a combination layer of iron nitrides; and
laser shocking the nitrided part with a laser to remove the combination layer.

2. The method according to claim 1, further comprising, before the step of nitriding the part, the steps of:
manufacturing a blank of the steel part is manufactured;
heat treating the blank; and
machining the blank to obtain a semi-finished part on which said nitriding is implemented,
wherein, for the laser shocking, the laser projects pulses with a power (P) of 5 J≤P≤30 J, and a duration of each pulse is between 1 and 30 nanoseconds.

3. The method according to claim 1, wherein the laser projects pulses at a wavelength (λ) such that 0.5 μm≤λ≤2 μm.

4. The method according to claim 1, wherein the combination layer generated by the nitriding has a thickness of between 2 and 40 μm before removal.

5. The method according to claim 1, wherein, for the laser shocking:
a laser beam is received directly on the nitrided steel of the part where a removal of material is implemented over a depth of between 5 and 50 μm, or
the part is previously covered with a material acting as a sacrificial and thermal-protection layer that the laser shock destroys, or
the part is protected by a confinement layer, which is a medium transparent to the laser, capable of interacting with the shockwave generated by the plasma caused by the interaction between the laser and the material.

6. The method according to claim 5, wherein the confinement layer is defined by a fluid having anti-corrosion properties and transparent to the wavelength of the laser used for the laser shock.

7. The method according to claim 1, which, before the laser shocking, is devoid of any step of grinding the part and of any step of applying at least one sacrificial layer to the part, a laser beam being, for the laser shocking, received directly on the nitrided steel of the part where a removal of material is implemented over a depth of between 5 and 50 μm.

8. The method according to claim 1, wherein the combination layer is used as a sacrificial layer that the laser shocking destroys.

9. The method according to any one of the preceding claim 1, wherein the laser shocking uses surface power densities of between 5 and 30 GW/cm2.

10. The method according to claim 1, wherein the method is devoid of any shot-blasting step.

11. The method according to claim 1, wherein the method further comprises a tribofinishing step.

12. The method according to claim 1, wherein, after the laser shocking on the part, a finishing of the part is implemented, to treat its surface state, in order to achieve at least a target roughness.

13. The method according to claim 12, wherein the finishing of the part comprises a tribofinishing step.

14. The method according to claim 1, wherein the part is one from a part with teeth or flutes, gearing, or bearing track.

15. The method according to claim 2, wherein, for the laser shocking, the laser projects pulses with the power (P) of 10 J≤P≤30 J.

16. The method according to claim 2, wherein, for the laser shocking, the laser projects pulses with a duration of each pulse between 5 and 30 nanoseconds.
